(19) United States
(12) Patent Application Publication
(10) Pub. No.: US 2006/0209695 A1
(43) Pub. Date: Sep. 21, 2006

(54) Load balancing in a distributed telecommunications platform

(76) Inventors: Shafford R. Archer JR., Norcross, GA (US); Florin D. Malita, Norcross, GA (US); Ian M. Moraes, Suwanee, GA (US); Jon S. Plotky, Lawrenceville, GA (US)

Correspondence Address: SMITH FROHWEIN TEMPEL GREENLEE BLAHA, LLC, P.O. BOX 88148, ATLANTA, GA, 30356, US

(21) Appl. No.: 11/170,457

(22) Filed: Jun. 29, 2005

Related U.S. Application Data
(63) Continuation-in-part of application No. 11/080,744, filed on Mar. 15, 2005.

(51) Int. Cl. H04J 1/16

(52) U.S. Cl. 370/235

(57) ABSTRACT

Processing is allocated within a distributed telecommunications at two levels—the component level and the process level. At the component level, a virtual switch is employed to route service requests to one of a group of components that are configured to process the service request. The decision can be made autonomously by the virtual switch or entirely based on information provided by the component or even by a combination of both. At the process level, each component establishes multiple instances of the serving process and then selects one instance to process the service requests. The component monitors the processing burden of the instance of the process and if a degradation in performance is anticipated, the component selects an alternative instance of the serving process to handle subsequent requests.

### CROSS-REFERENCE TO RELATED APPLICATIONS

This application is a continuation-in-part of, U.S. patent application Ser. No. 11/080,744 entitled DISTRIBUTED IP ARCHITECTURE FOR TELECOMMUNICATIONS SYSTEM filed on Mar. 15, 2005.

### BACKGROUND OF THE INVENTION

The present invention relates to distributed IP systems and telecommunication systems and, more particularly, to a multi-functional telecommunications system with geographically dispersible components that interact over a distributed IP architecture.

Over the past several decades, voice mail has continued to expand and establish itself as a key element in the successful operations of most businesses. The typical voice mail system today can take on a variety of forms, including a computer card that can operate within a personal computer that is connected to a businesses telephone system, or a computer card or component that is directly integrated into the businesses telephone system, or as a service provided by a telecommunications company.

The common ingredient to each of the voice mail systems available today is that the components that make up the voice mail system must communicate with each other and thus, must be co-located. This can be a great disadvantage for companies that have geographically dispersed offices.

In today's global economy, even small business may have a need for multiple offices for serving clients, interacting with vendors, or various other reasons. The advent of the Internet, email and video conferencing helps to allow such dispersed operations appear more seamless. However, a significant problem that still exists for dispersed offices is having a common telephonic system that operates as a single, co-located system but serves the needs of the various offices. Generally, each office purchases and maintains its own telephone system without any direct interface between the telephone systems of the various offices and without any central control. This can be a costly endeavor in that duplicative hardware must be purchased and maintained at each site. In addition, the logistics of inter-office communication such as call transfers, voice mail retrieval etc. can be complex. Thus, there is a need in the art for a telecommunications system that allows seamless integration for remotely located offices.

In most distributed systems, a common problem that arises and must be addressed is the distribution of processing between the various components. In a distributed system, a sub-set of the components can be overburdened with processing tasks while other components are idle or under utilized. Such a situation can result in tremendous and unnecessary decreases in the efficiency and throughput of the system. For instance, if the load can be distributed from overburdened components to under utilized components, the system can more efficiently handle the processing requirements. There are many such techniques that have been proposed and implemented in an effort to balance the processing requirements in distributed systems. However, such techniques are not adequate to meet the demands in the distributed telecommunications platform described herein. For instance, when one or more components utilize JAVA 2 Enterprise Edition (J2EE) environment and JAVA Server Pages (JSP), such as in creating dynamic VoiceXML pages, additional problems can arise. In such a component, the JAVA engine allocates and deallocates memory while performing what is termed in the art as garbage collection. This is a key feature of Java which takes care of freeing dynamically allocated memory that is no longer referenced. Because the heap is garbage-collected, Java programmers don't have to explicitly free allocated memory. However, when the garbage collection process commences, tremendous processing time can be required which directly impacts the performance of the system. Thus, there is a need in the art for a distributed system that allows for the reallocation of resources in a manner that avoids or alleviates the impact of a JAVA garbage collection process as well as other processing requirements.

### BRIEF SUMMARY OF THE INVENTION

This invention provides a technique for balancing the processing load within a distributed telecommunications system. In general, processing is distributed at two levels—the component level and the process level. At the component level, a virtual switch is employed to route service requests to one of a group of components that are configured to process the service request. The decision can be made autonomously by the virtual switch or entirely based on information provided by the component or even by a combination of both. At the process level, each component establishes multiple instances of the serving process and then selects one instance to process the service requests. The component monitors the processing burden of the instance of the process and if a degradation in performance is anticipated, the component selects an alternative instance of the serving process to handle subsequent requests.

In an exemplary embodiment of the present invention, the virtual switch is used to select between a group of application servers for handling telecommunication service requests. The application servers utilize a J2EE platform that includes a garbage collection process. If a single instance of the serving process is used, eventually the garbage collection process will require a high execution priority and at such a time, performance degradation would be experienced by users of the telecommunications system. The multiple instances allow the garbage collection process to operate off line without impacting the performance experienced by the users.

### BRIEF DESCRIPTION OF THE SEVERAL VIEWS OF THE DRAWING

FIG. 1 is a system diagram illustrating the components and the connectivity of an exemplary next-generation communications platform in which various aspects and features of the present invention can be utilized.

FIG. 2 is a block diagram illustrating one potential configuration for providing load balancing in accordance with the present invention.

FIG. 3 is a flow diagram illustrating various aspects of the present invention.

### DETAILED DESCRIPTION OF THE INVENTION

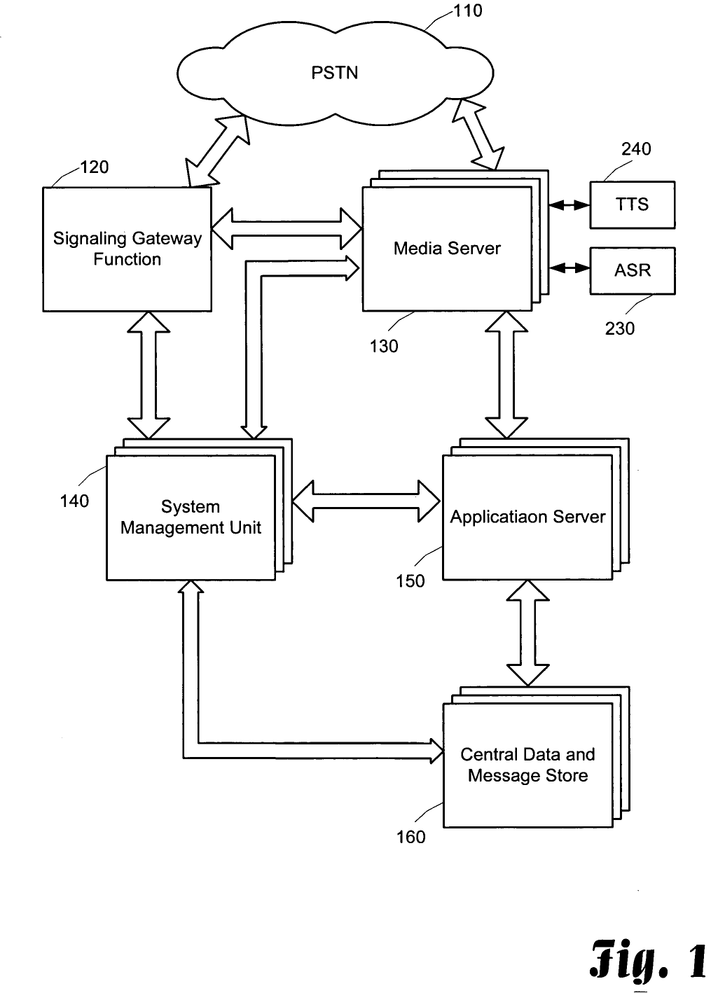

FIG. 1 is a system diagram illustrating the components and the connectivity of an exemplary next-generation communications platform in which various aspects and features of the present invention can be utilized. The illustrated system includes a distributed IP-based architecture for telecommunications equipment that, among other things, can provide telecommunication services such as voice mail, call forwarding and other telecommunication features. In the illustrated environment, the next-generation communications platform 100 has a distributed IP architecture and is connected to the Public Switched Telephone Network (PSTN) 110. The communications platform 100 is illustrated as including a signaling gateway function (SGF) 120, one or more media servers (MS) 130, one or more system management units (SMU) 140, one or more application servers (AS) 150 and one or more central data and message store (CDMS) 160. It should be understood that the distribution of functionality illustrated in the figures and described, although having novel aspects in itself, is not the only acceptable arrangement, and aspects of the present invention could be incorporated into a system that includes fewer or more components and a different arrangement of functionality among the components.

In general, the SGF 120 serves as the Signaling System 7 (SS7) interface to the PSTN 110 and allows one or more components or sub-systems to share the same point code (thereby reducing the need for destination point codes (DPC) and signaling links for call-control. This makes the telephonic system appear as single trunk group in the network. The media server 130 terminates IP and/or circuit switched traffic from the PSTN via a multi-interface design and is responsible for trunking and call control. The application server module 150 generates dynamic VoiceXML pages for various applications and renders the pages through the media server 130 and provides an external interface via a web application server configuration. The SMU 140 is a management portal that enables service providers to provision and maintain subscriber accounts and manage network elements from a centralized web interface. The CDMS 160 stores voice messages, subscriber records, and manages specific application functions including notification. Each of these sub-systems are described in more detail following.

Each of the components in the next-generation communications platform is independently scalable and independently interconnected onto an IP network. Thus, the components can be geographically distributed but still operate as a single communications platform as long as they can communicate with each other over the IP network. This is a significant advantage of the present invention that is not available in state-of-the-art communication systems.

Signaling Gateway Function (SGF)

The SGF 120 offers a consolidated signaling interface creating a single virtual SS7 signaling point for the next generation communications platform. SS7 provides the extra horsepower networks need, whether large or small. A SIGTRAN interface (IETF SS7 telephony signaling over IP) to the multi-function media server 130 as well as IP Proxy functions are supported via the SGF 120. Consolidating SS7 into a single component (in this case the SGF 120) of the next-generation communications platform provides the benefits of reduced point codes, cost efficiency in the design of the other components and easier maintenance.

Each signaling point in the SS7 network is uniquely identified by a numeric point code. Point codes are carried in signaling messages exchanged between signaling points to identify the source and destination of each message. Each signaling point uses a routing table to select the appropriate signaling path for each message.

There are three kinds of signaling points in the SS7 network: SSP (Service Switching Point), STP (Signal Transfer Point) and SCP (Service Control Point). SSPs are switches that originate, terminate or tandem calls. An SSP sends signaling messages to other SSPs to setup, manage and release voice circuits required to complete a call. An SSP may also send a query message to a centralized database (an SCP) to determine how to route a call (e.g., a toll-free 1-800/888 call in North America). An SCP sends a response to the originating SSP containing the routing number(s) associated with the dialed number. An alternate routing number may be used by the SSP if the primary number is busy or the call is unanswered within a specified time. Actual call features vary from network to network and from service to service.

Network traffic between signaling points may be routed via a packet switch called a Service Transfer Point or STP. An STP routes each incoming message to an outgoing signaling link based on routing information contained in the SS7 message. Because it acts as a network hub, an STP provides improved utilization of the SS7 network by eliminating the need for direct links between signaling points. An STP may perform global title translation, a procedure by which the destination signaling point is determined from digits present in the signaling message (e.g., the dialed 800 number, calling card number or mobile subscriber identification number).

An STP can also act as a “firewall” to screen SS7 messages exchanged with other networks. Because the SS7 network is critical to call processing, SCPs and STPs are usually deployed in mated pair configurations in separate physical locations to ensure network-wide service in the event of an isolated failure. Links between signaling points are also provisioned in pairs. Traffic is shared across all links in the link set. If one of the links fails, the signaling traffic is rerouted over another link in the link set. The SS7 protocol provides both error correction and retransmission capabilities to allow continued service in the event of signaling point or link failures.

The availability of point codes is typically limited. The consolidation of signaling links eases the pressure on these resources or eliminates the need for additional point codes altogether. Thus, the consolidated signaling interface in the SGF 120 provides immediate network simplification and cost savings. The SGF 120 presents the appearance of a single identity to the SS7 network via the single “virtual” point code of the messaging network and recognizes and processes messages in a transparent manner. The SGF 120 can potentially reduce the maximum number of point codes needed in some cases from 50 to only four.

From a networking perspective, the SGF 120 looks like an STP to the rest of the network giving access to the various components of the next-generation communications platform through the use of virtual point codes. In accordance with the distributed aspects of the present invention, multiple SGFs may be incorporated into the system. In this configuration, multiple paths to the various components of the next-generation communications platform are available.

Each SGF 120 includes virtual point codes that are used to access the various components in the communications platform. Only one destination point code is necessary for the entire communications platform. The SGFs communicate with each other to synchronize the virtual point codes for the media servers and other components integrated into the communications platform. Thus, if one SGF fails, access to the communications platform is easily provided through another SGF.

This is significantly different and advantageous over each of the components in the next generation communications platform looking like synchronized SS7 stacks.

In an exemplary embodiment, the SGF 120 server supports N+1 fail over redundancy schemes and load sharing configurations and is built on an Intel server. A minimum of two SGFs is recommended for load sharing and redundancy purposes for increased availability. As with all platform components, SNMP alarming, logging, and transaction detail records are generated. Features, advantages and benefits of the SGF include:

Allows multiple media servers to share signaling links and point codes providing significant cost savings;

Provides concentrated SS7 signaling links;

Can provide one trunk group across multiple multi-function media servers;

SGF 120 requires less SS7 links resulting in reduced monthly connection fees; and

The SGF 120 is a key component in the ability to implement an IP distributed architecture for the communications platform.

Media Server (MS)

The MS 130 terminates IP traffic from the SGF 120 and circuit-switched traffic from the PSTN 110. The MS 130 is responsible for call set up and control within the platform architecture. The MS 130 processes input from the user in either voice, DTMF format or other signaling schemes (much like a web client gathers keyboard and mouse click input from a user). The MS 130 then presents the content back to the user in voice form (similar in principle to graphic and text displayed back to the user on a PC client). This client/server methodology is important in the platform architecture in that it enables rapid creation of new applications and quick utilization of content available on the World Wide Web.

The MS 130 preferably processes incoming calls via requests to the AS 150 using HTTP. A load balancer preferably directs traffic arriving at the multi-function MS 130 to one of a plurality of ASs 150. This functionality ensures that traffic is allocated evenly between active servers. The multi-function MS 130 works as the VoiceXML client on behalf of the end user in much the same manner as a client like Netscape works on behalf of an HTML user on a PC. A VoiceXML or Call Control XML (CCXML) browser residing on a multi-function media server interprets the VoiceXML documents for presentation to users.

VoiceXML is a standards-based scripting language for developing voice-enabled software applications. This means that developers use and leverage Web-based (HTML) development expertise in developing speech-based telephony applications.

Application Server (AS)

The modular design of the next-generation communications platform has the added advantage that it is easy to deploy enhanced services, such as voice dialing and voice navigation, unified communications solutions, multimedia messaging services, and presence & availability management applications. Adding applications to the platform is accomplished via the addition of standard application servers 150 to the common platform.

Each application server 150 generates application documents (VoiceXML pages) in response to requests from the media server 130 via the internal Ethernet network. The application server 150 leverages a web application infrastructure to interface with back-end data stores (message stores, user profile databases, content servers) to generate the VoiceXML based documents.

The overall web application infrastructure separates the core service logic (i.e., providing the business logic) from the presentation details (VoiceXML, CCXML, SALT, XHTML, WML) to provide a more extensible application architecture. The application server 150 utilizes Java 2 Enterprise Edition (J2EE) environment and Java Server Pages (JSP) to create the dynamic VoiceXML pages for the multi-function media server. Combining these technologies enables rapid incorporation of Speech Application Language Tags (SALT) to provide interoperability (multimodal) between applications like WAP, HTML, XHTML and voice—allowing the end user to simultaneously input data via voice command and receive presentation via WAP or HTML.

To create an environment for easy application development, the application server 150 preferably supports Template+JSPs. Applications are implemented in JSPs using an API for access to messaging functions. These JSPs are readily modifiable making changes in application behavior and creation of new applications very easy.

The cooperation of the media server 130 and the application server 150 allows for customization of certain features to be offered to particular subscribers. For instance, if a company has one office on the west coast and another office on the east coast, the operation of the telephone system, particularly the media server 130 and the application server 150 for each office may be quite different. For instance, the voice mail system and auto attendant may go to night-time mode in the east coast office at 6:00 PM Easter Time and at the west coast office at 6:00 PM Pacific Time. In addition, the menu structure and prompts provided by the various offices may be substantially different. For instance, a dial by name directory would include different employees. With the present invention, separate media servers can be located at the two offices and the media servers 130 can render different communication services. The different communication services could be rendered from different application servers 150, co-located with the media servers 130, or through a common application server that can serve a communications services application based on the location or an ID of the media server 130.

In addition, remotely located media servers 130 can provide common functionality to the various subscribers and callers as well as provide a seamless integration of the telephone system from the perspective of both the subscribers and users. A company may want to present a voicemail and auto attendant interface that seamlessly serves all locations of the company. The present invention can be utilized to provide such functionality. The application server 150 can render a tiered dial by name or menu selection function that first allows callers to select an office and then, an application server 150 and/or media server 130 invokes a particular function to provide dial by name services for that particular office. Alternatively, the application server 150 may maintain access to a single CDMS 160 or multiple CDMSs 160 that include all of the subscriber information for all offices of the company. The application server 150 can then provide a single level menu structure for a company wide dial by name directory.

Common Database and Message Store (CDMS)

The next-generation communications platform uses the CDMS 160 to store voice/audio messages, subscriber records, and to manage certain application functions such as notification schedules. The CDMS 160 is preferably designed with fully redundant components and utilizes reflective memory and Redundant Array of Independent Disks (RAID) technology for fault tolerance, immediate fail over and recovery. This ensures a higher level of certainty that the system will be available even during adverse circumstance. Essential disk drive and RAID controller components are preferably “hot swappable” eliminating the need to power down the system for replacements. With the CDMS 160, performance is optimized for the unique characteristics of voice messaging, eliminating the performance degrading, unnecessary e-mail-centric database functionality that comes with the searching and sorting of e-mail stores.

The CDMS 160 can utilize standard off the shelf e-mail storage systems. The message store is abstracted through the use of Java middleware that allows the selection of the message store to be transparent to the application, enabling each message type to be stored in the most efficient store possible.

System Management Unit (SMU)

The SMU 140 provides a centralized point for service providers to manage all network elements, providing remote access, maintenance, and backup functionality. The SMU 140 provides a single interface for provisioning, alarming, reports, and subscriber migration. The SMU 140 integrates and customizes systems with new elements and applications, and provides operational support and network management functions for carriers experiencing swiftly growing networks and exploding traffic volumes. Core features of the SMU component include:

Element Auto-Discovery—when service providers add new network elements, the SMU automatically recognizes them and includes the new elements in the graphical network map.

Graphical Network Map—a network/cluster map and map editor provides a snapshot of the entire network or cluster and facilitates quick problem identification and resolution.

Time Synchronization—a central time source ensures all network components maintain a uniform time reference across the entire messaging network—important for any distributed architecture.

Centralized network logging—logging for the entire messaging network is centralized on the SMU 140.

The SMU 140 uses a dual processor computer and allows remote dial-in for access to the SMU 140 server as well as all other servers in the system via Telnet. Backup of system configurations and other critical data can also accomplished via the SMU.

Advantageously, the next-generation communications platform as described, allows for the quick and cost-effective deployment of a variety of applications, all from a single architectural source. Utilization of an open-source, Java-based Applications Creation environment makes this high degree of flexibility possible. Utilizing the communications platform, operators can create compelling bundles of best-in-class messaging and communications services ranging from basic call answering to forward looking applications like multimedia messaging and presence enabled solutions. To further facilitate the user experience, the next generation communications platform may also provide a web interface for subscribers to add and modify their preferences and features on a “self-serve” basis. This capability increases usage by consumers, improves customer loyalty, and also reduces service provider operating costs through fewer routine service calls.

Another advantage of the communications platform is the ability to include and incorporate a variety of applications. Whether the application is native on the platform or sourced from a third party vendor, the applications allow the communications platform to be customized for various customer needs and product differentiation. Some of the applications that can be easily incorporated into the communications platform include, but are not limited to, the following applications:
Voice Mail—Provides subscribers with a variety of features designed around the exchange of voice messages content including voice message recording and storing, forwarding, remote retrieval, etc.
Missed Call Notification—This is an extension of Caller ID is frequently used in wireless or cellular telephone arenas. Caller ID service only provides an incoming call number if the wireless phone is on and in the network coverage area. However, Missed Call Notification provides a continuous, network-based service providing subscribers a list of calls that were placed to the cellular telephones number while the user was away from the cellular telephone or the cellular telephone was turned off. Thus, Missed Call Notification service will capture and store the incoming call information until the cellular telephone is turned on and registers. At that time, a Short Message Service message (SMS message) containing a list of all missed calls is sent to the subscriber, allowing the subscriber to return calls at his or her convenience.
Multimedia Messaging Service—MMS allows subscribers to personalize their communications with up-to-the-minute multimedia content such as photos and music to create messaging that breaks the boundaries of traditional communication. This application is enhance by employing features such as Message Composer, Photo Album and Greeting Cards, to allow subscribers to send and receive dynamic multimedia content on their MMS-capable mobile phones, PDAs and PCs. Subscribers can also send multimedia content to non-MMS subscribers via the Internet, driving traffic to an operator's website thereby increasing subscriber usage.
Unified Communications—A complete package of services customized to a particular subscribers' needs, including voice, fax and e-mail messaging, a single mailbox for all message types, an integrated address book, and special on-line management and personalization tools.
Multi-Party Personal Conference Service—This application gives subscribers the ability to initiate instant conferences with friends/family.
Voice-Enabled Messaging Services—This application is a powerful voice-controlled telephony service. Subscribers have access to an array of services through their own personal contact number and an easy-to-use voice interface that features natural language recognition and optional text-to-speech capability. Features common to a Voice Enabled Messaging Suite include navigation of voice mail via spoken commands, voice dialing and a voice controlled address book, delivered on an IP-based architecture compliant with industry standards such as VoiceXML and SALT.
Voice MMS—This application enables subscribers to have greater access and control over their communication channels by allowing newly deposited voice mail messages to be delivered to an MMS-capable handset or e-mail box in the form of an audio clip. Subscribers can also share voice messages via e-mail and to forward voice messages to destinations outside of their voice mail system.

Another aspect of the present invention is a transaction vehicle for the delivery of control and data. Utilizing the same SGF 120 components as previously described, a transactional vehicle centered around the TCAP component of the SS7 protocol is provided. More specifically, short messaging service can be provided within the distributed architecture of the next-generation communications platform utilizing the TCAP component of the SS7 protocol. A sender of a short message establishes communication with a media server 130 over the IP network. The sender gets the media server 130 to request the SGF 120 to send an SS7 TCAP message for the delivery of the short message. This technique brings the single point access node as described above for the STP Interface for SGF for call processing into transactional processing.

Thus, the distributed architecture for the exemplary telecommunications platform allows for various functions of the telecommunications platform to be geographically distributed yet, work as a seamlessly integrated system. A problem that arises in such distributed systems is the sharing of resources within the system. Many situations can arise in which multiple components may be over burdening certain other components with service requests. In addition, certain components may be more resilient on processing requests at certain times, and less resilient at other times. An example of such a situation occurs when one or more of the component include a Java 2 Enterprise Edition environment and employ the use of garbage-collection for recapturing unused memory.

JAVA Garbage Collection

As previously mentioned, the application server 150 utilizes Java 2 Enterprise Edition (J2EE) environment and Java Server Pages (JSP) to create the dynamic VoiceXML pages for the multi-function media server. A key feature of Java is its garbage-collected heap, which takes care of freeing dynamically allocated memory that is no longer referenced. Because the heap is garbage-collected, Java programmers don't have to explicitly free allocated memory. In general, when the garbage collection process kicks it, the application server 150 is unavailable for use by any other processes or at least its usability is diminished. If the application server 150 is utilized in an environment that is latency sensitive, such as a voice mail platform or telephone system, the entrance of the application server 150 into the garbage collection process can impose latency problems. Thus, in a telephone call, the participants would hear dead air during the garbage collection process.

More specifically, a J2EE server/web container is a software component that is used to support server applications that support requests from clients. Some J2EE server/web container applications have service requirements that cannot afford to incur the performance overhead imposed by Java Virtual Machine's (JVM) garbage collection activity such as a major garbage collection. For these applications, there is an initial period where performance is acceptable until a service affecting garbage collection activity occurs.

The JVM's heap stores all objects created by an executing Java program. Objects are created by the Java's process, and memory for new objects is allocated on the heap at run time. Garbage collection is the process of automatically freeing objects that are no longer referenced by the program. The name “garbage collection” implies that objects that are no longer needed by the program are “garbage” and can be thrown away. When an object is no longer referenced by the program, the heap space it occupies must be recycled so that the space is available for subsequent new objects. The garbage collector must somehow determine which objects are no longer referenced by the program and make available the heap space occupied by such unreferenced objects.

In addition to freeing unreferenced objects, a garbage collector may also combat heap fragmentation. Heap fragmentation occurs through the course of normal program execution. New objects are allocated, and unreferenced objects are freed such that free blocks of heap memory are left in between blocks occupied by live objects. Requests to allocate new objects may have to be filled by extending the size of the heap even though there is enough total unused space in the existing heap. This will happen if there is not enough contiguous free heap space available into which the new object will fit. On a virtual memory system, the extra paging required to service an ever growing heap can degrade the performance of the executing program.

Several garbage collection techniques maybe utilized on a Java platform depending on the application and the programming technique. Regardless of the method utilized, the latency problems associated with the process will most likely be realized. Historically you could only give hints to the garbage collection mechanism, which made it very difficult to tune the process, thus requiring our recycler solution.

A garbage collection algorithm must do two basic things. First, it must detect garbage objects. Second, it must reclaim the heap space used by the garbage objects and make it available to the program. Garbage detection is ordinarily accomplished by defining a set of roots and determining reachability from the roots. An object is reachable if there is some path of references from the roots by which the executing program can access the object. The roots are always accessible to the program. Any objects that are reachable from the roots are considered live. Objects that are not reachable are considered garbage, because they can no longer affect the future course of program execution.

One aspect of the present invention is to allow a J2EE server or web container (e.g., Resin, Apache Tomcat, BEA WebLogic, IBM WebSphere) to only process requests for a configurable period before service affecting garbage collection activity occurs. The overall design approach is that there is more than one instance of a web container/server on a host with only one of the containers/servers considered active and processing new session requests. After a configurable period and in order to avoid a service affecting garbage collection activity, the active container/server is then quiesced and demoted to a standby state with new session requests directed to a newly promoted active container/server. A load distribution component that gets the initial new session request distributes the requests to the currently active container/server. After a container/server is promoted from active to standby mode, the load distribution component sends new session requests to the newly promoted container/server. This process continues for as long as the host is active.

Although the mechanism is intended to support more than two containers/servers at a time, for discussion purposes, it is assumed that two containers/servers reside on a single host. At any time, only one of the containers/servers is in an active mode (receives requests from new clients); the other is in a standby mode. Only the active container/server can accept requests from new clients (new sessions are created). After a configurable time period (which can be derived based on empirical data or be programmed to default values or expected values), the standby container/server is promoted and begins to receive new session requests while the formerly active container/server does not receive new session requests but continues to process requests for existing sessions and is then quiesced after a configurable period. The quiesced container/server is shutdown and restarted (this cleans up any garbage and provides a “clean slate”) after which it is kept in a standby mode until it is again promoted to an active mode after a configurable time period. This process is repeated for as long as the host is configured to accept requests. Thus, new requests are directed to the active web container/server on the same host and thus transparently and without failure web requests to that host are processed without incurring the overhead of a service affecting JVM garbage collection. The same mechanism is used to support more than two containers/servers.

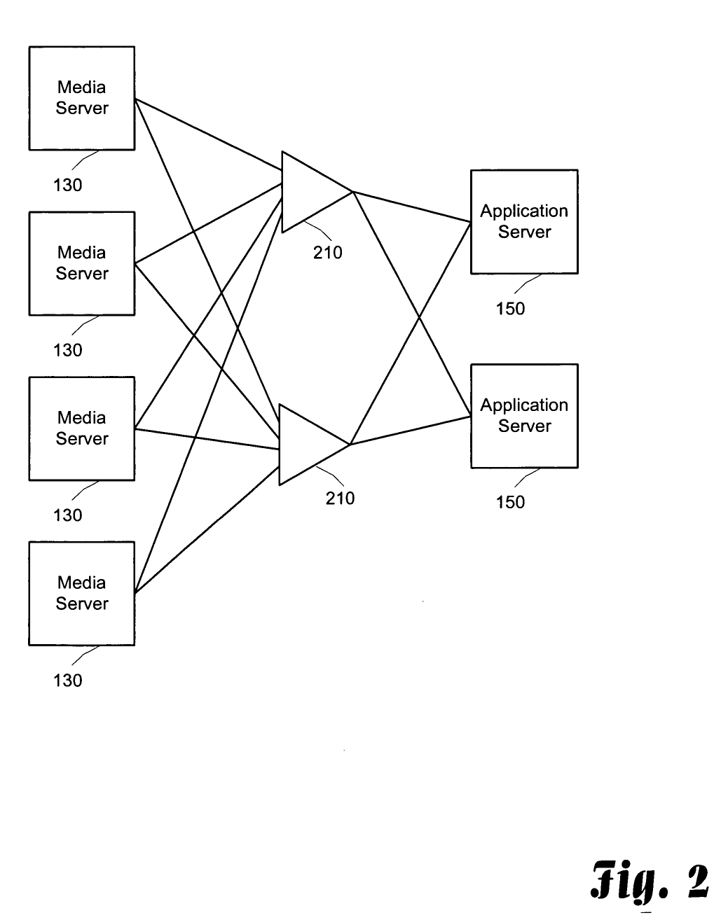

FIG. 2 is a block diagram illustrating one potential configuration for providing load balancing in accordance with the present invention. The illustrated configuration includes four media servers 130 and two application servers 150. Each of the media servers 130 can access either of the application servers through one of the two virtual switches 210. One embodiment of the virtual switch can be redundant pair of layer 4 load balancers. The virtual switch 210 can be any of a variety of components that operate to redirect service requests from multiple requesters to multiple recipients. One such component could be the Linux Virtual Server (LVS). The LVS is a highly scalable and highly available server built on a cluster of real servers, with a load balancer running on the Linux operating system.

When a request arrives at a virtual switch 210 from a media server 130, the virtual switch 210 routes the request to an application server 150 based on the current load and availability of the application servers 150 serviced by the virtual switch 210. Thus, a media server 130 posts a message to the virtual switch 210. The virtual switch determines which application server 150 will be used to respond to the request and notifies the application server 150. The application server 150 then responds back to the requesting media server 130.

Each of the application servers 150 includes a port. The virtual switches 210 route requests to the application servers 150 by sending the request to the appropriate port. The virtual switch 210 provides load balancing in at least two manners. In one instance, the virtual switch 210 can monitor the number of requests that have been routed to a particular application server 150 and redirect requests to another application server 150 if the virtual switch 210 concludes that the application server 150 is over utilized. The virtual switch 210 can use a weighting process to make this determination. A weight is assigned to each host and the current number of connections to the host. An algorithm is known as weighted least-connection is used as the basis for making this determination. For example, the virtual switch 210 can route one percentage of the traffic to a first application server 150 and remaining percentage of traffic to one or more other application servers 150. In another instance, the application servers 150 can actively instruct the virtual switches 210 to utilize a different application server 150. For example, if a first application server is too busy, the application server 150 can instruct the virtual switch 210 to route further requests to a different application server. This can be done on an indefinite basis (i.e., until the application server 150 instructs the virtual switch 210 that it is again available), or it can be done on a temporary basis (i.e., for a period of time or for a certain amount of traffic). Thus, the virtual switch 210 operates to provide load balancing within the telecommunications platform.

The LVS can balance based on individual component load information provided from a feedback mechanism on the application server hosts 150. For example, the application server containers within the application server also have the ability to indicate a status, such as “I'm available” or “I'm dead”. The application servers may also provide a percentage busy status, such as “I'm n % busy”. This status information can then be used as input to the request scheduling decision made by the LVS.

Load balancing is also provided on the application server level in another manner—garbage collection. One aspect of the present invention for the performance of garbage collection is to create two instances of a virtual machine for servicing requests. Each instance of the virtual machine includes its own garbage collection process. In general, the virtual switch 210 routes request to a first virtual machine within an application server 150 for a period of time, and then further requests are routed to a second virtual machine while the first virtual machine performs garbage collection. The decision for switching between the virtual machines can be based on a variety of factors and the present invention is not limited to any particular scheme. For instance, in one embodiment, the switch-over may be performed on a periodic basis (i.e., every 30 minutes). In other embodiments, the switchover maybe performed based on the number of requests that have been sent to the virtual machine, the amount of memory available to the virtual machine, the number of threads that are being processed by the virtual machine, or the like.

Within each virtual machine, the garbage collection process is generally the lowest or a very low priority task. Thus, as the application server 150 is being utilized, the garbage collection requirements accumulate overtime. At a certain point in time, typically when available memory is running low, the garbage collection process must be moved to a higher priority. If the garbage collection process kicks in while active processes are being serviced by the application server 150, the users of the system will experience dead time or latency.

The present invention operates to switch between the virtual machines before this critical juncture is met. Thus, before the garbage heap for one virtual machine becomes so severe that the garbage collection process must be moved to a higher priority, thereby degrading system performance, further requests for service are routed to the other virtual machine. Advantageously, this allows the first virtual machine to continue serving the currently active processes and the garbage collection process will not be given a higher priority due to the introduction of new processes that may require memory. Once requests are being routed to the other virtual machine, the garbage can be cleaned up in one of two manners. The virtual engine can be restarted which automatically invokes the garbage collection process. However, the processes that are currently being serviced would result in being terminated. Thus, a more amenable technique is to allow the currently active process to continue and as processing resources become available, or after the last process is terminated, to conduct the garbage collection process. Because new requests are routed to the other virtual machine, it is simply a matter of time before the garbage collection process can be invoked. Once the garbage collection process is invoked, then the first virtual machine can become available for handling future requests. In addition, the JVM process can be restarted which results in releasing all heap memory owned by the JMV process and thereby avoiding the garbage collection process altogether.

It should be understood that although this aspect of the present invention is described as including two virtual machines, any number of virtual machines could also be used and the routing of requests to the virtual machine can be conducted in a round robin fashion or otherwise.

Thus, the present invention operates to provide load balancing in at least two manners. At one level, the virtual switch balances the load directed towards the application servers 150. At another level, the application servers 150 allocate the processing of requests between two or more virtual machines in a manner to avoid latency problems due to garbage collection.

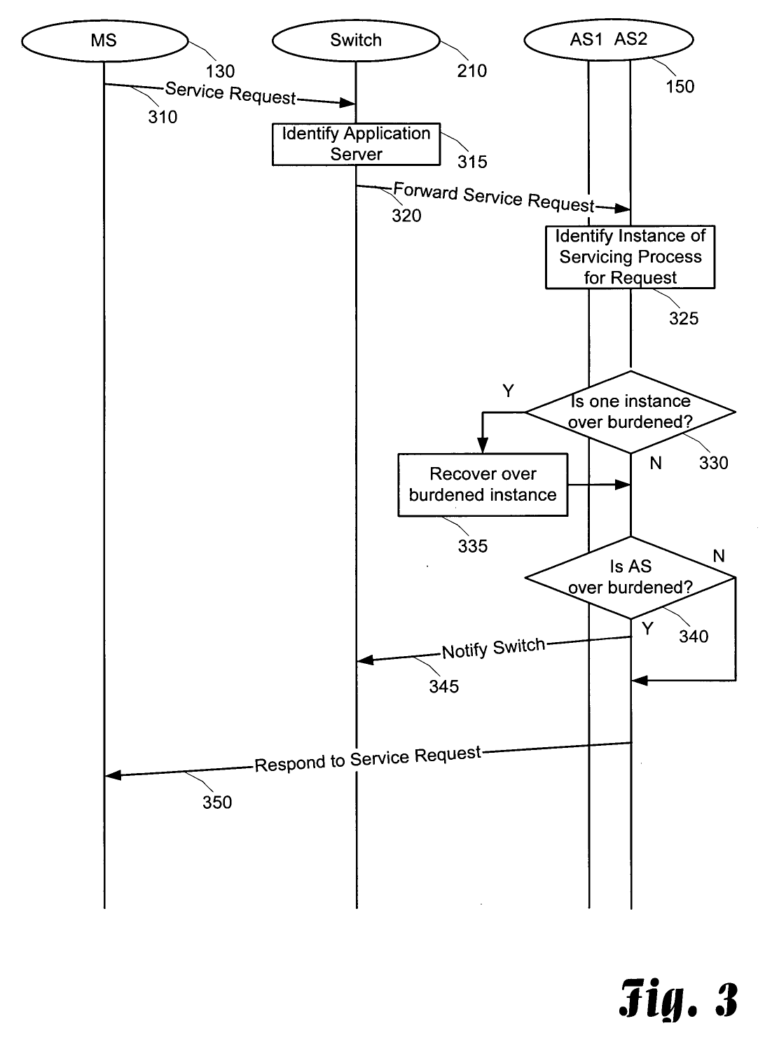

FIG. 3 is a flow diagram illustrating various aspects of the present invention. The flow diagram illustrates a Media Server 130 communicating with one or more Application Servers 150 through a virtual switch 210. Although only one Media Server 130 and one Virtual Switch 210 and two Application Servers 150 are illustrated, it should be understood that the various aspects of the present invention are not limited to such a configuration. As previously described, the present invention provides load balancing in a distributed telecommunications platform in at least two manners: balancing the load between application servers and balancing the load within an application server. Initially, a service request 310 is provided by the Media Server 130 to the virtual switch 210. At this point, the virtual switch 210 makes a determination as to which Application Server is appropriate for processing the service request 310 315. This determination can be performed in a variety of manners ranging from being autonomously performed by the virtual switch, being performed by the virtual switch subservient to the Application Server, or by any combination of these two extremes. For instance, the virtual switch may monitor the number of requests, the processing requirements for the requests, and the capacity of the application servers to make a determination as to the ability of the application server to accept and process additional requests. Alternatively, the application servers may send status information to the virtual switch to indicate their current processing load and their ability to accept and process additional requests. Thus, the virtual switch 210 can make a loading distribution decision (1) autonomously, (2) based on control/status information from the application server or (3) based on information gathered by the virtual switch in combination with information received from the application server.

Once the desired Application Server 150 is selected, the virtual switch 210 forwards the service request to the select Application Server 150 320. Ultimately, the Application Server 150 will respond to the service request either through the virtual switch 210 or directly with the Media Server 130 350. However, the Application Server 150 may also conduct additional steps regarding the processing allocation of the Application Server 150. One such process, involves creating various instances of a serving process that is used to handle incoming service requests. As previously described, this aspect of the present invention advantageously allows for the implementation of a J2EE environment without incurring performance degradation during the garbage collection process. Thus, prior to or subsequent to receiving a service request, the Application Server 150 may operate to create multiple instances of the serving process and then identify a particular instance to handle a current service request 325. During operation, the Application Server 150 can distribute the processing load by using different instances of the serving process. This can be accomplished in a variety of manners, some of which have been disclosed herein, as well as other, not disclosed manners that are still anticipated by the present invention. Regardless of the manner selected, the Application Server 150 determines if an instance of the serving process is overburdened 330 and if so, operates to allow the overburdened instance to recover 335. For example, in one embodiment the present invention operates to determine an optimal point at which the garbage collection process will be required to be moved to a higher priority and then, directing additional service requests to an alternate instance to avoid the performance degradation due to the garbage collection process.

The Application Server 150 may also collect, analyze and report information back to the virtual server 210 to control, or support the control of the selection of an application server. This is performed by the Application Server 150 periodically determining its own status 340 and then reporting 345 this information to the virtual switch 210. Thus, the virtual switch scan then utilize this information in determining which Application Server 150 to which addition service requests should be routed.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

What is claimed is:

1. A method for providing two-levels of load balancing in a distributed system in which a plurality of a first class of components must share the resources of a plurality of a second class of components, and wherein the first class of components interface to the second class of components through one or more switching systems, the method comprising the steps of:
receiving a service request from one of the plurality of first class components at one of the switching systems;
the switching system identifying one of a plurality of a second class of components for processing the request;
forwarding the request to the identified second class component, the identified second class component being operable to establish at least two instances of a servicing process for handling the request;
receiving the request at the identified second class component; and
assigning the request to one of the at least two instances of the service process for handling the request, the assignment being based at least in part on the current processing requirements of the at least two instances of the process.

2. The method of claim 1, wherein each instance of the servicing process in the identified second class component includes a garbage-collection process for freeing unused memory and, the step of assigning the request to one of the at least two instances of the service process if further based on the status of the garbage-collection process that is operating within the service process instances.

3. The method of claim 1, wherein each instance of the servicing process in the identified second class component includes a garbage-collection process for freeing unused memory and, the step of assigning the request to one of the at least two instances of the service process if further based on the necessity to prioritize the operation of the garbage-collection process within the service process instances.

4. The method of claim 1, wherein each instance of the servicing process in the identified second class component includes a garbage-collection process, the garbage collection process operating as a low-priority background task to free unused memory and, the step of assigning the request to one of the at least two instances of the service process is performed by assigning the request to a first instance of the service process until it is necessary to increase the priority of the garbage-collection process for the first instance, and then assigning subsequent requests to another instance of the service process.

5. The method of claim 1, wherein each instance of the servicing process in the identified second class component includes a garbage-collection process, the garbage collection process operating as a low-priority background task to free unused memory and, the step of assigning the request to one of the at least two instances of the service process is performed by assigning the request to a first instance of the service process for a particular period of time, and then assigning subsequent requests to another instance of the service process, the particular period of time being sufficient to prevent overburdening of the first instance.

6. The method of claim 1, wherein each instance of the servicing process in the identified second class component includes a garbage-collection process, the garbage collection process operating as a low-priority background task to free unused memory and, the step of assigning the request to one of the at least two instances of the service process is performed by assigning the request to a first instance of the service process until a first threshold memory utilization is reached, and then assigning subsequent requests to another instance of the service process.

7. The method of claim 6, wherein once the memory utilization in the first instance of the service process drops below a second threshold, assignment of the service requests are returned to the first instance of the service process.

8. The method of claim 1, wherein each instance of the servicing process in the identified second class component includes a garbage-collection process, the garbage collection process operating as a low-priority background task to free unused memory and, the step of assigning the request to one of the at least two instances of the service process is performed by assigning the request to a first instance of the service process until a first threshold number of service requests have been sent to the first instance, and then assigning subsequent requests to another instance of the service process.

9. The method of claim 1, wherein the step of the switching system identifying one of a plurality of a second class of components for processing the request further comprises identifying a first component for handling a first percentage of requests and identifying a second component for handling the remaining percentage of requests.

10. The method of claim 1, wherein the step of the switching system identifying one of a plurality of a second class of components for processing the request further comprises identifying a first component for handling a first percentage of requests and identifying a second component for handling the remaining percentage of requests.

11. The method of claim 1, wherein the step of the switching system identifying one of a plurality of a second class of components for processing the request further comprises identifying a first component for handling a first threshold number of requests.

12. The method of claim 1, wherein the step of the switching system identifying one of a plurality of a second class of components for processing the request further comprises:
receiving an indication from each of the plurality of second class components identifying current loading of the component; and
selecting one of the plurality of the second class of components based at least in part on the current loading of the components.

13. A distributed telecommunications system that provides load balancing for processing of service requests, the system comprising:
a media server that interfaces to a telephone system for providing telecommunication services;
one or more switches;
two or more application servers that are interfaced to the media sever through the one or more switches;
each of the application servers being operable to service requests received from the media server by:
creating multiple instances of a serving process;
using a first instance of the serving process to handle all service requests until the first instance reaches a threshold burden level; and
switch to another instance of the serving process to handle subsequent service requests.

14. The distributed telecommunications system of claim 13, wherein each of the application servers utilize a JAVA 2 Enterprise Edition environment with each instance of the servicing process including a garbage-collection process for freeing unused memory and, each of the application servers are operable to switch to another instance of the serving process when the garbage-collection process of the first instance of the serving process requires a higher priority.

15. The distributed telecommunications system of claim 13, wherein each of the application servers utilize a JAVA 2 Enterprise Edition environment with each instance of the servicing process including a garbage-collection process for freeing unused memory and, the threshold burden level is determined by the amount of time the first instance has been in use for handling service requests.

16. The distributed telecommunications system of claim 13, wherein each of the one or more switches are operable to select an application server of the two or more application servers that a request from the media server is routed to, thereby providing load balancing for the distributed telecommunications system.

17. The distributed telecommunications system of claim 16, wherein the each of the one or more switches are operable to select an application server based on the number of requests being processed by the application server.

18. The distributed telecommunications system of claim 16, wherein each of the one or more switches are operable to select an application server based on status information received from the two or more application servers.

19. The distributed telecommunications system of claim 13, wherein each of the application servers utilize a JAVA 2 Enterprise Edition environment with each instance of the servicing process including a garbage-collection process for freeing unused memory and, each of the application servers are operable to switch to another instance of the serving process when the garbage-collection process of the first instance of the serving process requires a higher priority and wherein each of the one or more switches are operable to select an application server based on the number of requests being processed by the application server.

20. The distributed telecommunications system of claim 13, wherein each of the application servers utilize a JAVA 2 Enterprise Edition environment with each instance of the servicing process including a garbage-collection process for freeing unused memory and, each of the application servers are operable to switch to another instance of the serving process when the garbage-collection process of the first instance of the serving process requires a higher priority and wherein each of the one or more switches are operable to select an application server based on status information received from the two or more application servers.
